(19) United States
(12) Patent Application Publication
(10) Pub. No.: US 2003/0165203 A1
(43) Pub. Date: Sep. 4, 2003

(54) Quadrature gain and phase imbalance correction in a receiver

(76) Inventor: Rishi Mohindra, Milpitas, CA (US)

Correspondence Address: Perkins Coie LLP, 101 Jefferson Drive, Menlo Park, CA, 94025, US

(21) Appl. No.: 10/365,309

(22) Filed: Feb. 12, 2003

Related U.S. Application Data
(63) Continuation-in-part of application No. 09/927,762, filed on Aug. 10, 2001.

(51) Int. Cl. H04L 27/14; H04L 27/16; H04L 27/22

(52) U.S. Cl. 375/324; 375/371

(57) ABSTRACT

The present invention offers a low cost, reliable, on chip implementation that takes advantage of circuitry already present in receivers to calibrate and correct for gain and phase errors in a transceiver device. The present invention employs a digital signal processor along with multiple phase shifters and all pass networks to ensure proper levels of quadrature signals within the transceiver. An internally generated double sideband suppressed carrier signal is created to produce the calibration signals used by the digital signal processor.

### CROSS REFERENCE TO RELATED APPLICATIONS

This application is a continuation in part of currently pending U.S. application Ser. No. 09/927,762 filed Aug. 10, 2001, which is herein incorporated by reference.

### STATEMENT REGARDING FEDERALLY SPONSORED RESEARCH

None

### BACKGROUND OF THE INVENTION

The invention relates to a method for correcting the gain and phase imbalance in quadrature paths of a receiver.

In radio communication systems, different types of modulation schemes are employed to minimize the frequency spectrum necessary for communication and thereby maximize the call capacity of the radio communication system. The modulation schemes utilized usually involve converting the communication signal into discrete form, and the resultant modulated signal is typically of a reduced frequency spectrum.

One method of transmitting a communication signal in discrete form is through the use of quadrature modulation. In quadrature modulation, the binary data stream of the encoded communication signal is separated into bit pairs. Such bit pairs are utilized to cause phase shifts of the RF carrier signal in increments such as plus or minus π/4 radians or plus or minus 3π/4 radians, according to the values of the individual bit pairs of the encoded signal.

The phase shifts are effectuated by applying the binary data stream comprised of the bit pairs to a pair of mixer circuits. A sine component of a carrier signal is applied to an input of a first mixer circuit, and a cosine component of a carrier signal is applied to an input of a second mixer circuit. The sine and cosine components of the carrier signal are in a relative phase relationship of ninety degrees with one another, or phase quadrature. A quadrature generator is utilized to generate and apply the sine and cosine components of the carrier signal to the first and second mixer circuits of the pair of mixer circuits, respectively. This produces what is referred to as in-phase “I” and quadrature “Q” signals. These I and Q signals are then filtered by channel filters in each of the I and Q paths, gain adjusted, and finally sent to a Digital Signal Processing chip to extract the communicated data.

There are two major sources of I and Q signal errors in this type of receiver. First, I and Q gain and phase errors result from the down conversion to base band or intermediate frequency IF caused by the mixing circuits. Second, frequency dependent I and Q gain and phase errors result from differences in the channel filters between the I and Q signal paths. These types of errors are due to gain and phase mismatches between the quadrature receiver paths after down conversion (e.g. between the I and Q low pass filters and between the I and Q gain control blocks). Therefore the IQ errors that need to be calibrated and corrected are, a) IQ gain errors (combined systematic and frequency dependent), b) systematic IQ phase errors, and c) frequency dependent IQ phase errors.

The prior art has used higher tolerance components in an attempt to avoid phase and/or amplitude imbalances between the I and Q components. Such an approach has significant cost impact and may still not adequately address the problem. Other prior art approaches attempt to account for imbalances by estimating and removing these errors.

One error estimation approach is described in U.S. Pat. No. 5,396,656 issued on Mar. 7, 1995, to Jasper et al., entitled a Method For Determining Desired Components Of Quadrature Modulated Signals. This is shown in Prior Art FIG. 1. Here, a closed loop feedback technique is used to continuously determine an error signal by updating estimates of an imbalance component until the magnitude of the error signal is negligible. This prior art circuit contains standard components such as an antenna 301, a local oscillator 302, an A/D converter 303, and a Digital Signal Processing chip 304. The DSP 304 includes mixing circuits 305 and 306 and a phase shifter 307. The signals are then summed by adder 308 and then low pass filtered by element 309. The signal is then sampled by sampler 310, where the magnitudes of the components are estimated and the imbalance of the I and Q signals are determined by elements 311-314. The final error correction process is then accomplished by the desired component determiner 315 used in conjunction with the DSP. The drawback of this technique is that all these feedback components (310-315) must be supplied in addition to the already required components found in I and Q receivers. This adversely effects the cost and complexity of the device. Further, even with all these extra circuit elements, adequate error compensation is not fully realized.

Thus, conventional I and Q correction circuits rely on providing additional components for the minimization of errors. Other corrective devices such as a separate PLL and VCO are too costly to provide additionally. Therefore a solution is required that takes into account all the above mentioned problems and limitations associated with quadrature imbalance correction circuits without requiring additional expensive circuitry.

### SUMMARY OF THE INVENTION

The present invention generates a receiver calibration signal used to measure these errors common to IQ receivers. The present invention then corrects the errors determined in the calibration mode. Specifically, the gain errors of the I and Q signals are calibrated and corrected. The systematic phase errors of the I and Q branches are calibrated and corrected. Also the frequency dependent phase errors are calibrated and corrected.

In order to accomplish the above goals, the invention employs a digital signal processor to control the calibration and correction processes. One embodiment of the present invention includes an IQ circuit containing mixers, filters and gain controlling devices. This embodiment further includes multipliers and phase shifters that are used in conjunction with the DSP to determine the phase error between the I and Q components. The present invention further provides several embodiments for each type of error calibration and correction. For example, the systematic phase errors may be corrected using a look-up table or they may be corrected iteratively by the digital signal processor. The frequency dependent phase errors may also be corrected using phase shifters or an all-pass network.

Therefore the present invention offers a low cost, reliable, on chip implementation that takes advantage of circuitry already present to detect and correct for all the different types of errors found in IQ quadrature receiver circuits.

### BRIEF DESCRIPTION OF THE DRAWINGS

FIG. 1 shows a Prior Art quadrature imbalance correction circuit.

FIG. 2 shows a circuit of the present invention.

FIG. 2A shows a flowchart detailing one method of the present invention.

FIG. 3 shows the phase shifter P2 as shown in FIG. 2.

FIG. 4 shows another embodiment of the present invention.

FIG. 4A shows a circuit of the present invention.

FIG. 4B shows a circuit of the present invention.

FIG. 4C shows a circuit of the present invention.

FIG. 5 shows an all pass network that may be used in a preferred embodiment of the present invention.

FIG. 6 shows a graph of phase angle versus frequency for the all pass networks.

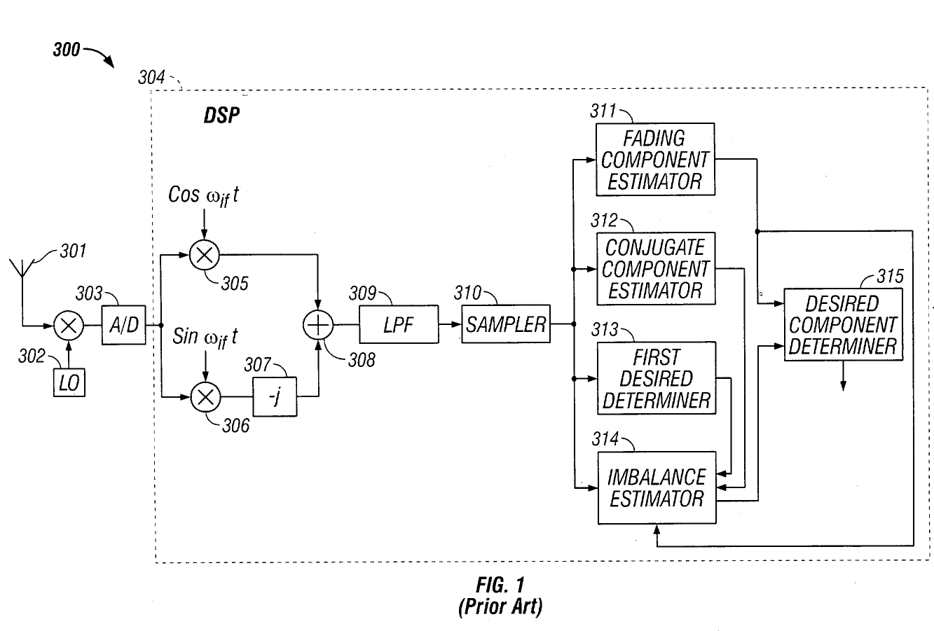

### DETAILED DESCRIPTION OF THE INVENTION

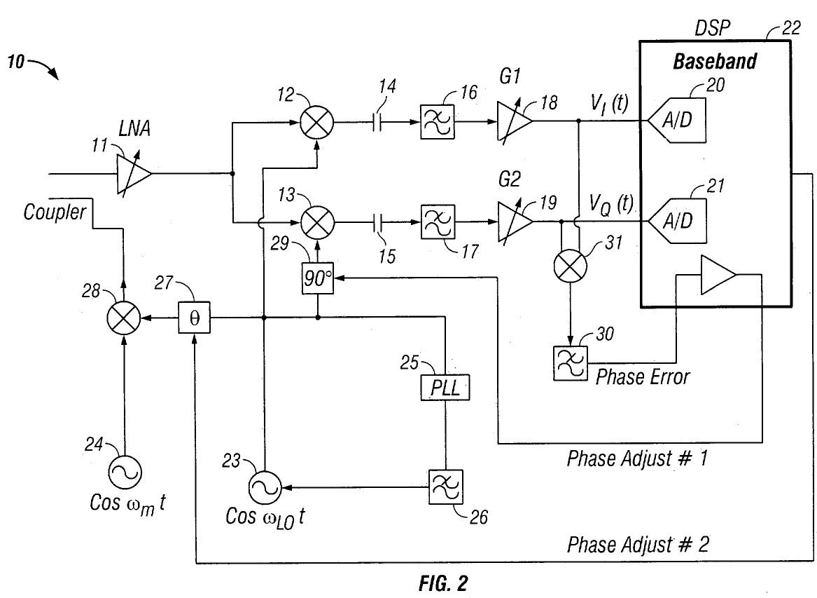

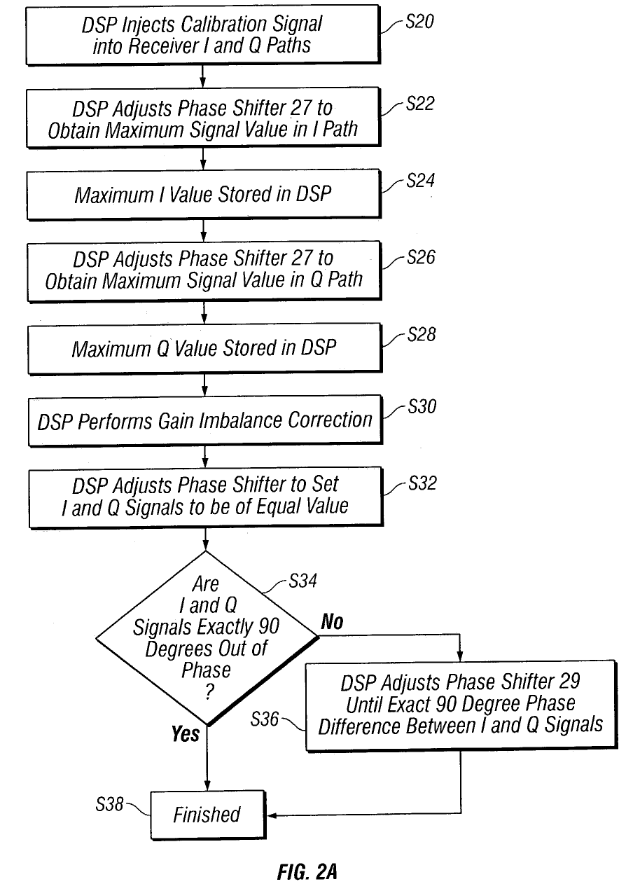

FIG. 2 shows one of the preferred embodiments of the present invention. FIG. 2 illustrates a communications device 10 suitable for receiving and correcting I and Q (In phase and Quadrature phase) signals. There are two essential parts to the device 10, the path of the received signals and the signal path of the signals used to mix with the received signals. In this embodiment the received signal path includes a low noise amplifier 11, two mixers 12 and 13, two coupling capacitors 14 and 15 and two filters 16 and 17. Finally the signal path contains gain amplifiers 18 and 19 before the received signal is input into A/D converters 20 and 21 for processing by the digital signal processor 22. The mixing signals are produced using local oscillators 23 and 24, a phase locked loop 25, a filter 26, a phase shifter 27 and a mixer 28.

In the received signal path, the LNA 11 is a standard low noise amplifier commonly used to amplify low power high frequency RF signals. The incoming radio signal into 11 comes from an antenna not shown. The received signal will be broken into quadrature components by using mixing circuits 12 and 13 and phase adjusting circuit 29. The outputs of 12 and 13 will become the baseband signals. For example, if the incoming signal has a bandwidth of 20 MHz, each of the I and Q branches will be signals of 10 MHz bandwidth. As is conventional in quadrature circuits, capacitors 14 and 15 are used to block any dc component of received signal and filters 16 and 17 are used to further filter unwanted signals. Before any quadrature modulation is performed however, it is critical that the receiver be properly calibrated.

In order to produce a reliable calibration tone in the mixing signal path, the local oscillator 23 is mixed with a low frequency tone produced by 24. An example of these frequencies would be 23 set at 5 Gigahertz, while 24 is set at 5 Megahertz. The local oscillator 23 is also used with a Phase Locked Loop (PLL) 25 and a filter 26. These two signals are multiplied by a mixing circuit 28. The resulting multiplication of two sine waves of differing frequencies results in two signals being produced, wherein the resulting sine wave are at different frequencies. For example cos (A)×cos (B)=cos (A+B)+cos (A−B). Therefore the mixer 28 produces two signals for the calibration process. As mentioned previously, prior art methods do not employ circuitry nor signals of this type for the calibration signal generators. Standard prior art methods employ only one tone for calibration purposes whereas the instant invention uses two. In this example the frequencies are 5 GHz+5 MHz and 5 GHz−5 MHz. It is noted that this Double Side-Band Suppressed Carrier signal (DSBSC) may be coupled in the receiver's RF path at either the input or the output of 11.

The two calibration tones will be fed into mixers 12 and 13 for quadrature processing. Using two tones for calibration however, would pose a problem for prior art circuits. In this scenario the In-phase branch would be a clear signal but the Quadrature phase would be zero. In order to overcome this problem a Phase Shifter 27 is implemented. The phase shifter 27 adds an angel theta to the frequency of a calibration tone signal. For example, when 27 is set to zero, VI(t) is cos (wt) and VQ(t) is zero. When 27 is set to 90 degrees, the VI(t) signal is nonexistent while VQ(t) is cos (wt).

The calibration method using Phase Shifter 27 would then be as described with reference to FIG. 2A. In order to start the calibration process, a calibration signal is injected into the receiver I and Q paths in step S20. In step S22 27 is adjusted so as to obtain the maximum value of signal in the VI(t) branch. The adjustment of 27 is performed by the Digital Signal Processing chip 22. In step S24, the maximum signal level is measured by baseband processor chip 22 and stored. Then 27 is adjusted by 90 degrees until the signal in the Q branch is at a maximum level in step S26. The maximum level of the Q branch is also measured and stored in the baseband processor chip 22 in step S28. Once these maximum values of each branch are known, the baseband processor chip may perform a gain imbalance calibration in step S30. This gain imbalance correction may be performed by amplifiers 18 and 19 (with gains G1 and G2) or after analogue to digital signal conversion (A/D) in the baseband processor chip 22. It is noted that G1 and G2 may perform the gain adjustments for the receiver as a whole. It is also noted that G1 and G2 are controlled together as opposed to separately. The I and Q gains are therefore made equal to avoid any sideband production and distortion of the desired signal. The present invention also allows for gain imbalance calibration to be performed at any level of gain as set by G1 and G2.

With respect to this IQ phase error calibration, the present method continues in step S32 where 27 would be set at a value such as 45 degrees. This ensures a signal in both the I and Q branches of almost equal value. By simply multiplying the two signals together one can detect the relative phase of the I and Q branches. The product of a sine and cosine signal should result in zero and this is determined in step S34. Mixer circuit 31 accomplishes the multiplication of the I and Q signals and outputs this signal to a filter 30. If this is not the case, meaning that the I and Q branches are not exactly 90 degrees out of phase as desired, a phase error signal is produced. This signal is fed back through an amplifier and filter 30 to Phase Shifter 29 that will compensate for the error in step S36. Ideally the phase difference between the I and Q branches should be 90 degrees. This process is finished in step S38 when the I and Q signals are determined to be exactly 90 degrees out of phase. Therefore, the adjustment of 27 with the appropriate gain control in addition with the adjustment of 29, allow for an optimum phase imbalance to be performed. It is noted that 29 may be in the RF path instead of being in the local oscillator path if desired.

In a second embodiment, the phase shifter 27 may be used in another manner than the one described above. In this embodiment, the phase shifter is constantly varying the angle of shift. For example, theta starts at zero and constantly increases. While the amount of phase shift varies, the in-phase and quadrature signals will vary in amplitude. At some values of theta both signals are present, while other values of theta result in only one of the two signals being present. As in the previous embodiment, the peak amplitudes of each of the in-phase and quadrature signals are measured by the DSP chip 22. This allows another way to detect the maximum amplitudes needed for gain compensation.

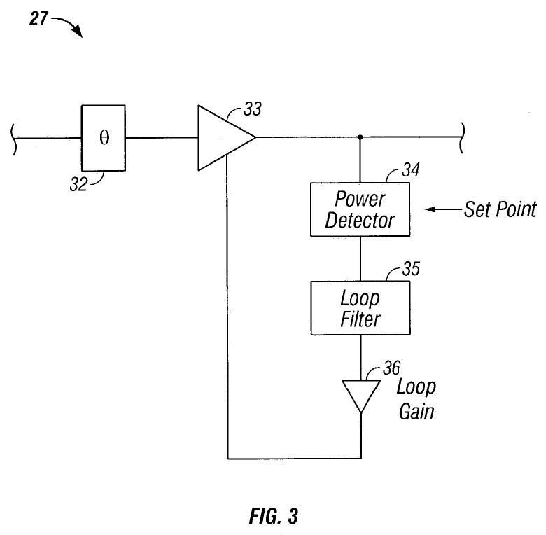

FIG. 3 of the present invention shows one embodiment of how the Phase Shifter 27 (as shown in FIG. 2) may be implemented. In addition to the actual phase shifting device 32, this expanded view of the phase shifter 27 includes, an amplifier 33, and a feedback loop comprising a power detector 34, a loop filter 35 and a loop gain amplifier 36. Given that the amplitudes of the signals involved in the calibration process are critical, it is important that 27 does not modify the signal strength of the signal that it is shifting. Therefore it must be ensured that 27 will not provide gain or loss to the signal for any range of shift in degrees. In the present invention, the output of 27 has a constant amplitude independent of the phase shift. A limited or automatic gain control device would be used to ensure his constant output voltage level. FIG. 3 shows the use of a power detector 34 that determines the power of the calibration signal. This detected power is compared to a set point value. If the signal is somewhat off the desired set point level, an error signal may be generated to compensate for this fact. A loop filter 35 and loop gain amplifier 36 help keep the output of the circuit constant for all phase shifts. This allows phase shifter 27 to output a constant signal amplitude as desired and not adversely effect the calibration process.

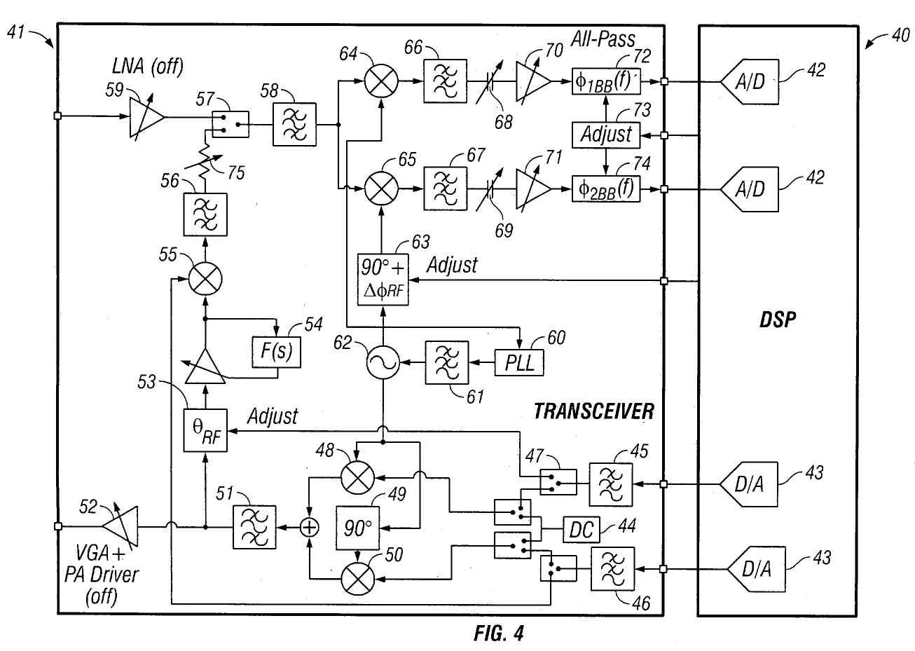

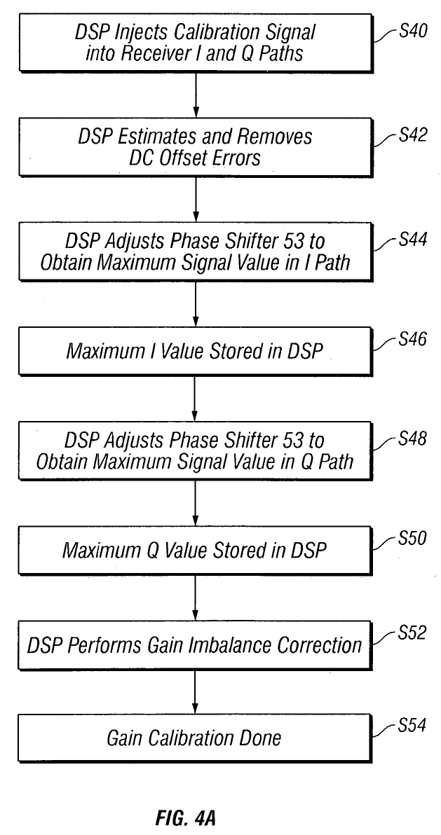

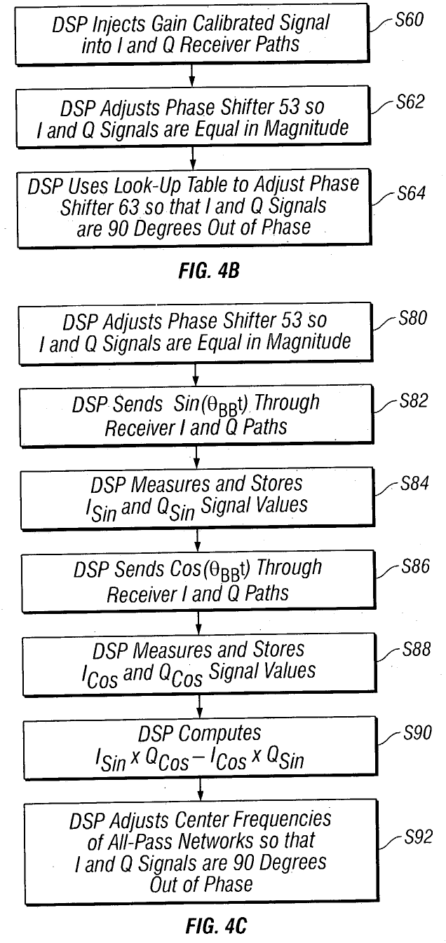

In another preferred embodiment of the present invention, the systematic and frequency dependent IQ gain and phase errors in the receiver are calibrated using the circuit as shown in FIG. 4.

The transceiver in FIG. 4 is similar to that shown in FIG. 2. There is both a received signal path and a mixing/calibration signal generating path. In the received signal path the signal is first sent through a Low Noise Amplifier (LNA) 59. After passing through the LNA, the signal is coupled by a switch 57 to a bandpass filter 58. Down converters 64 and 65 further process the signal to create the I and Q branches as is conventional. The I and Q signals are then filtered and amplified by elements 66, 67, 70 and 71. Variable capacitors 68 and 69 serve to AC couple the signal in what is known as the automatic gain control portion of the receiver. All pass networks 72 and 74 are adjusted by a signal 73 from the DSP to ensure proper phase relationships between the I and Q branches. The operation and control of the all-pass networks exemplifies one embodiment of the phase error correction method and apparatus which will be described in more detail below.

For the calibration process an RF tone is generated by the DSP 40 in the transmitter path at the center frequency of the receiver pass band. This is done by applying a DC signal from generator 44, to the base band I and Q modulation inputs of the transmitter. This RF tone is passed through a bandpass filter 51, a programmable phase shifter 53, and then multiplied by a sine wave in multiplier 55 at a low frequency of F_{BB}. This produces a DSB-SC (double side band, suppressed carrier) modulated signal. F_{BB} is the base band frequency of interest at which the receiver's frequency dependent IQ error calibration is being done. For the frequency dependent IQ error, F_{BB} ranges from 0 Hz to about 8.5 MHz in an IEEE802.11a WLAN transceiver. The RF phase shifter 53 may be referred to as a “DSB-SC phase shifter” since it effectively changes the phase of the suppressed carrier of the DSB-SC modulated signal. A variable gain control amplifier configuration 54 ensures that the phase adjusting circuit 53 does not change the signal levels.

The DSB-SC calibration signal generated by the DSP is then coupled into the receiver path before the down conversion by coupling switch 57. After down conversion to base band frequencies and low-pass filtering, the receiver I and Q output signals are at a frequency of F_{BB}. This is because the local oscillator frequency for the transmitter and the receiver are kept equal. The gain calibration operation of this circuit is described below with reference to FIG. 4A.

The transmitter RF tone is Sin(ω_{RF}.t) and it is mixed with a base band modulation tone Sin(ω_{BB}.t). After multiplication in mixer (55), the DSB-SC modulated signal is Sin(ω_{RF}.t)Sin(ω_{BB}.t). In step S40 in FIG. 4A, the DSB-SC signal is injected into the receiver RF path by switch 57, down converted to I and Q base band frequencies, low-pass filtered, and then it appears at the receiver output with all the above mentioned IQ errors. Equations 1 and 2 describe the I and Q branch signals found in the circuit of FIG. 4 with the errors contained therein.

I(t)=A.(1+ΔG/2). Sin(ω^{BB}.t+Δφ_{BB}/2). Cos(θ_{RF}) [Eqn. 1]

Q(t)=A.(1−ΔG/2). Sin(ω_{BB}.t−Δφ_{BB}/2). Sin(θ_{RF}−Δθ_{RF}) [Eqn. 2]

Where

A=constant

ΔG=IQ gain imbalance in the receiver at F_{BB} (includes both systematic and frequency dependent errors)

Δφ_{BB}=frequency dependent base band IQ phase error in the receiver, at frequency F_{BB}

θ_{RF}=total (adjustable) RF phase shift in the calibration tone path prior to injection into receiver

Δφ_{RF}=systematic IQ phase error in the receiver

ω_{BB}=2πF_{BB}

If the receiver base band IQ output is DC-coupled to the A/D of the DSP chip 40, the DC offset errors also have to be removed and this is accomplished in step S42. This DC error can be estimated by averaging the I and Q signals over a period that is an exact multiple of 1/F_{BB}. When AC coupling is employed during calibration, the lower −3 dB frequency is kept at least 10 times smaller than F_{BB} in order to ensure that any asymmetry in the frequency roll-off between the I and Q paths doesn't impact the IQ gain error. Therefore, in order to enact other subsequently described embodiments of the present invention, a DC error must be removed before proceeding with the IQ Gain Error Calibration.

The DSP 40 will use equations 1 and 2 as listed above, in order to implement it's programmed error correction process. For IQ gain imbalance calibration in step S44, the DSP 40 adjusts the DSB-SC phase shifter 53 so that the I-branch has maximum signal. In this case Cos(θ_{RF})−1 i.e. θ_{RF}=0. After accurately measuring the rms signal level in the I-branch in S46, the DSB-SC phase shifter 53 is stepped by 90 degrees and finely adjusted to get the maximum level in the Q-branch in step S48. In this case Sin(θ_{RF}Δφ_{RF})=1 i.e. θ_{RF}=π/2+Δφ_{RF}. The Q-branch signal is then measured by the DSP 40 in step S50. The relative IQ gain imbalance at F_{BB} is the ratio of these two rms signal levels.

The systematic IQ gain imbalance may be measured by the DSP 40 by keeping the frequency F_{BB} at a very small value. In some cases, the average gain imbalance over the pass band (e.g. over 0 to 8 MHz for IEEE802.11a) may also be considered. The IQ gain imbalance is corrected in the DSP chip in real time after the A/D conversion in step S52. This is accomplished by relatively scaling the I and Q gain in time domain (independent of pass band frequency). After gain correction is finished in step S54, the ΔG term in equations 1 and 2 becomes negligible.

The IQ gain error calibration needs to be done over the gain range of the receiver if the error varies significantly with gain. In order not to overload the receiver, the level of the DSB-SC tone injected into the receiver must decrease with increasing gain of the base band gain control. Therefore a programmable attenuator 75 is required in the path of the DSB-SC signal. This can be done at the RF frequencies, but better still at the base band, i.e. the amplitude of the base band modulation signal Cos(ω_{BB}.t) or Sin(ω_{BB}.t) can be attenuated. However, when this amplitude gets small, the direct leakage of the unmodulated RF tone through the mixer can get significant and even become larger than the DSB-SC signal. Fortunately, with AC coupling in the receiver (capacitors 68 and 69), this unmodulated tone that gets down converted to 0 Hz, gets removed. This ensures that the receiver base band paths are not overloaded or saturated.

Therefore once the gain is calibrated and corrected by the DSP 40, a systematic IQ phase error calibration may be performed in another embodiment of the present invention.

Using the following technique, the IQ systematic phase error calibration is not influenced by the choice of F_{BB} in the pass band i.e. F_{BB} does not have to be close to 0 Hz. A suitable F_{BB} is chosen by the DSP 40 (say at half the maximum pass band frequency of the low-pass filters 66 and 67), and the IQ gain calibration is done at that frequency using the previously defined method as detailed in FIG. 4A.

Referring to FIG. 4B, in step S60 the DSP injects the signals produced from the method described in FIG. 4A. These IQ gain calibrated signals are:

I(t)=Sin(ω_{BB}.t+Δφ_{BB}/2). Cos(θ_{RF})

Q(t)=Sin(ω_{BB}.t−Δφ_{BB}/2). Sin(θ_{RF}−Δφ_{RF})

The first step would be to vary θ_{RF} (with the DSB-SC phase shifter 53) over a range greater than π/2 and record the maximum I and Q rms levels over this range of θ_{RF}.

Iₘₐₓ(t)=A. Sin(ω_{BB}.t+Δφ_{BB}/2) at θ_{RF}=0

Qₘₐₓ(t)=A. Sin(ω_{BB}.t−Δφ_{BB}/2) at θ_{RF}=π/2+Δφ_{RF}

They should be equal after the gain calibration, i.e. Iₘₐₓ(rms)=Qₘₐₓ(rms)=A/√2

In step S62 the DSB-SC phase shifter 53 is adjusted so that I and Q rms signal levels are exactly equal at the same time and measure their corresponding rms levels:

Iᵣₘₛ=Qᵣₘₛ i.e. Cos(θ_{RF})=Sin(θ_{RF}−Δφ_{RF})=A_{ΔφRF} [Eqn. 3]

The DSP would then normalize Iᵣₘₛ and Qᵣₘₛ it to the max rms levels Iₘₐₓ(rms) and Qₘₐₓ(rms) i.e. to A/√2.

Iᵣₘₛ/Iₘₐₓ(rms)=Cos(θ_{RF})=A_{ΔφRF}

Qᵣₘₛ/Qₘₐₓ(rms)=Sin(θ_{RF}−Δφ_{RF})=A_{ΔφRF}

In step S64 the DSP would use the normalized level A_{ΔφRF} to find the corresponding IQ phase error Δφ_{RF} in a look-up table. The look-up table basically lists the solution of equation 3 and would be stored in an internal memory in the DSP 40.

Another different approach and embodiment is described to accomplish the systematic phase error correction that is similar to the method of FIG. 4B.

For this correction, the receiver 41 should allow the systematic phase error Δφ_{RF} to be adjusted to zero (IQ relative phase adjustment in either RF path or in local oscillator path). When the systematic phase error is removed, Δφ_{RF}=0, and from equation 3

Cos(θ_{RF})=Sin(θ_{RF}−Δφ_{RF})=A_{ΔφRF}=1/√2 exactly.

Both Δφ_{RF} and θ_{RF} are adjusted iteratively by the DSP to get the optimum result of A_{ΔφRF}=1/√2 exactly from Equation 3.

Therefore, for a starting setting of Δφ_{RF} first adjust the DSB-SC phase shifter 53 θ_{RF} of the calibration tone to make I and Q rms levels equal and check Equation 3 if A_{ΔφRF}=1/√2 exactly. If A_{ΔφRF}=/=1/√2, change the value of Δφ_{RF} by small increments and adjust the DSB-SC phase shift θ_{RF} again to make I and Q rms levels equal. Finally, check Equation 3 to see if A_{ΔφRF}=1/√2 exactly. If not, repeat the process until A_{ΔφRF}=1/√2 exactly. In other words, the steps in this process are equivalent to those shown in FIG. 4B except the final phase adjustment is performed iteratively by the DSP instead of using a look-up table.

Using this method, the systematic IQ phase error can be calibrated by the DSP 40 independently of the frequency dependent IQ phase error.

As described in the Background of Invention section, frequency dependent IQ phase errors must also be calibrated and corrected. In another embodiment realized by the present invention, the frequency dependent IQ phase errors may be calibrated in the following manner with reference to FIG. 4C.

The IQ phase errors due to filter errors in the base band paths (66 and 67) are computed at a frequency F_{BB}. For a base band calibration tone of Sin(ω_{BB}.t) in the transmitter, the corresponding receiver signals are

I ₛᵢₙ(t)=A.(1+ΔG/2). Sin(ω_{BB}.t+Δφ_{BB}/2). Cos(θ_{RF})

Q ₛᵢₙ(t)=A.(1−ΔG/2). Sin(ω_{BB}.t−Δφ_{BB}/2). Sin(θ_{RF}−Δφ_{RF})

Where

A=constant

ΔG=IQ gain imbalance in the receiver

Δφ_{BB}=frequency dependent base band IQ phase error in the receiver, at ω_{BB}

θ_{RF}=total (adjustable) RF phase shift in the calibration tone path

Δφ_{RF}=systematic IQ phase error in the receiver

For a base band calibration tone of Cos(ω_{BB}.t) in the transmitter, the corresponding receiver signals are

I _{cos}(t)=A.(1+ΔG/2). Cos(ω_{BB}.t+Δφ_{BB}/2). Cos(θ_{RF})

Q _{cos}(t)=A.(1−ΔG/2). Cos(ω_{BB}.t−Δφ_{BB}/2). Sin(θ_{RF}−Δφ_{RF})

The calibration procedure would begin with step S80 with the DSP 40 adjusting θ_{RF} to approximately π/4 so that

Cos(θ_{RF})≅Sin(θ_{RF}−Δφ_{RF})≅1/√2(i.e. I and Q signals are approximately of equal magnitude).

Once this is done, in step S82 a signal, Sin(ω_{BB}.t) is sent as the base band calibration tone in the transmitter. The DSP then captures the corresponding IQ signals as I ₛᵢₙ(t) and Q ₛᵢₙ(t) in S84. In S86 the DSP sends Cos(ω_{BB}.t) as the base band calibration tone in the transmitter, and captures the corresponding receiver I and Q signals as I _{cos}(t) and Q _{cos}(t) respectively in step S88, while keeping θ_{RF} constant (at approximately π/4). The time “t” is measured in different reference frame for the two cases, and t=0 i.e. start of the capture is taken after many cycles of the transmitter base band tone Sin(ω_{BB}.t) or Cos(ω_{BB}.t) so that any transient disturbance in the low-pass filters in both transmitter and receiver have significantly decayed. From the captured signals, the DSP computes I ₛᵢₙ(t). Q _{cos}(t)−I _{cos}(t). Q ₛᵢₙ(t) in step S90. This step is preferably done over multiple cycles of ω_{BB} in order to average out any noise. Equation 4 below represents this error.

$$\begin{matrix}{I}_{sin} ( t ) \cdot {Q}_{cos} ( t ) - {I}_{cos} ( t ) \cdot {Q}_{sin} ( t ) = K1 \cdot [ Sin ( {ω}_{BB} \cdot t + {Δϕ}_{BB} / 2 ) \cdot Cos ( {ω}_{BB} \cdot t - {Δϕ}_{BB} / 2 ) - \\ Cos ( {ω}_{BB} \cdot t + {Δϕ}_{BB} / 2 ) \cdot Sin ( {ω}_{BB} \cdot t - {Δϕ}_{BB} / 2 ) ] \cdot [ Cos ( {θ}_{RF} ) \cdot Sin ( {θ}_{RF} - {Δϕ}_{RF} ) ] \\ = K2 \cdot Sin ( {Δϕ}_{BB} ) \cdot [ Cos ( {θ}_{RF} ) \cdot Sin ( {θ}_{RF} - {Δϕ}_{RF} ) ] \\ = K3 \cdot Sin ( {Δϕ}_{BB} ) i . e . constant and dependent on {Δϕ}_{BB}\end{matrix} \qquad [ Eqn . 4 ]$$

The DSP 40 then adjusts Δφ_{BB} in the receiver and minimizes the value of |I ₛᵢₙ(t). Q _{cos}(t)−I _{cos}(t). Q ₛᵢₙ(t)| that is computed from the captured data. This final adjustment performed in step S92 is accomplished by adjustment of all-pass networks as will be described below.

Therefore once the frequency dependent errors are calibrated, they may be corrected. Usually the frequency dependent IQ phase error varies linearly with frequency, starting at 0 degrees at 0 Hz, and possibly reaching a few degrees at the band edge. This is largely due to mismatches between the cutoff frequencies of the I and Q low-pass filters. The frequency dependent IQ phase error is corrected by cascading adjustable all-pass networks 72 and 74 in the I and Q base band signal paths. These all pass networks will be under the control of the DSP 40.

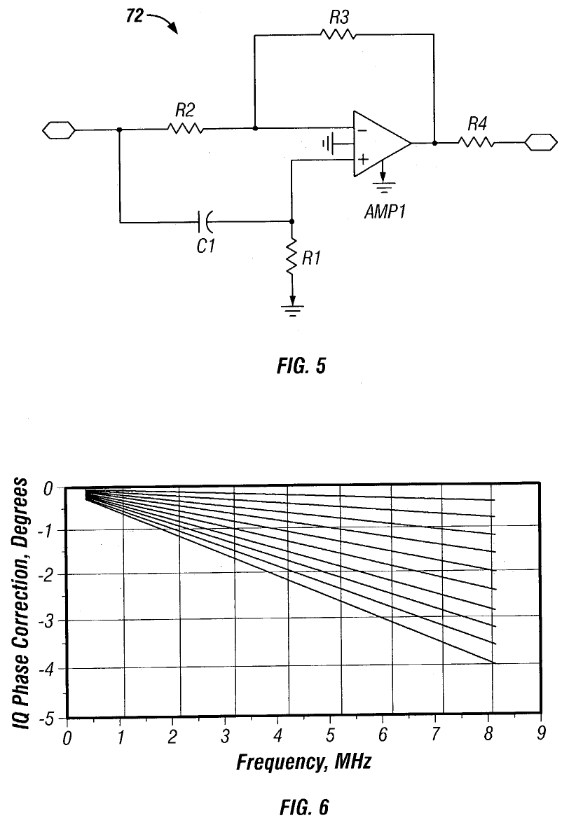

One such example of an all-pass network is shown in FIG. 5. This network comprises resistors R1, R2, R3 and R4, along with one capacitor C1 and 1 operational amplifier. This type of all-pass network passes signals of all frequencies with no change in gain. The use of the capacitor C1 does introduce a slight phase shift in the signal output however. This is desireable so that a relative phase mismatch between two such circuits can be introduced by setting these networks to slightly different frequencies from each other. The frequency (f0_MHz) of these networks is defined as f0_MHz=(2πR1.C1)⁻¹ where R1 is in ohms and C1 is in microfarads. Producing a phase mismatch between the all-pass networks allows for IQ phase error compensation as described below.

The relative phase mismatch response between two such networks is shown in FIG. 6 for various relative frequency mismatches. This graph shows networks that are centered around a nominal value of 20 MHz. For example, a 10% mismatch between the two circuits implies that the nominal f0_MHz values are 19 and 21 MHz for the two networks respectively. R1 and/or C1 of each network is adjusted to introduce a relative frequency mismatch that results in a particular Δφ_{BB} IQ phase mismatch at a particular F_{BB} (see FIG. 6). The DSP 40 adjusts R1 and/or C1 in the receiver all-pass networks and minimizes the value of |I ₛᵢₙ(t). Q _{cos}(t)−I _{cos}(t). Q ₛᵢₙ(t)| that is computed from the captured data. In this manner the frequency dependent IQ relative phase error is corrected within the transceiver. The largely linear variation of this error over the frequency range allows for I and Q phase errors to be corrected. For example, if the I and Q branches are 85 degrees out of phase, the all-pass network frequencies are adjusted by the DSP 40 to provide an extra 5 degrees of shift to provide true quadrature signals (i.e. 90 degree separation). Further, when performed at a base band frequency F_{BB}, this inherently ensures that the phase error will be smaller at lower frequencies.

The advantage of using all-pass networks is that they do not introduce any frequency dependent IQ gain imbalances that other networks like low-pass filters etc suffer from. Therefore any phase error produced in the RF path may be compensated for by the frequency adjustments of the all-pass networks 72 and 74, by the DSP 40.

In the above description of the present invention, the DSP is contained on one intergrated circuit chip, while the transceiver is contained on another separate chip. The Digital Signal Processing chip would be manufactured to contain the appropriate digital hardware and software to allow for the above methods to be performed. The transceiver chip would be manufactured to fabricate the components as shown n the drawings. It is also noted however that some structures, such as the all-pass filters for example, may be manufactured to be on either the DSP or the transceiver chip without departing from the scope of the invention. Therefore the invention should not be limited to its method of fabrication.

As described above, the present invention both determines and corrects automatically the systematic gain and phase errors, and the frequency dependent phase errors common to IQ quadrature transceivers. As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for correcting a phase error imbalance between in-phase (I) and quadrature (Q) components of a calibration signal comprising the acts of:
adjusting a phase angle to determine a peak amplitude for the in-phase component of the calibration signal;
adjusting the phase angle to determine a peak amplitude for the quadrature component of the calibration signal;
adjusting the phase angle to set the amplitudes for the in-phase and quadrature components of the calibration signal to be approximately equal at the same time;
sending a sine wave signal Sin(ω_{BB}.t) through an I and Q branches of a receiver circuit to measure I ₛᵢₙ(t) and Q ₛᵢₙ(t);
sending a cosine wave signal Cos(ω_{BB}.t) through the I and Q branches to measure Q _{cos}(t) and I _{cos}(t);
computing |I ₛᵢₙ(t) Q _{cos}(t)−I _{cos}(t) Q ₛᵢₙ(t)|=K3 Sin(Δφ_{BB}); and
adjusting a second phase angle (Δφ_{BB}) based on the computation of K3 Sin(Δφ_{BB}) so that the in-phase and quadrature components of the received signal are 90 degrees out of phase.

2. The method of claim 1, wherein the second phase angle is adjusted by using a look-up table.

3. The method of claim 2, wherein the lookup table contains mathematical solutions to an equation.

4. The method of claim 3, wherein the second phase angle is adjusted by a digital signal processing chip.

5. A communications device for correcting imbalance between in-phase and quadrature components of a signal comprising:
a quadrature receiver for receiving signals and converting the received signals into in-phase baseband (I) and a quadrature baseband (Q) signals, wherein the quadrature receiver contains amplifiers and filters in both an in-phase signal path and a quadrature signal path; and
a digital signal processor for determining an imbalance in the quadrature receiver between the inphase and quadrature signal paths of a test signal under varying conditions, wherein the digital signal processor sends a sine test signal and a cosine test signal through the in-phase and quadrature paths of the receiver.

6. The communication device of claim 5, wherein the digital signal processor varies the phases of the I and Q signals to enact a phase adjustment correction.

7. The communication device of claim 6, wherein the digital signal processor computes a difference in the product of test signals within the I and Q branches in order to adjust the phase between the I and Q branches.

8. The communication device of claim 7, wherein the digital signal processor enacts a correction mode after a calibration mode.

9. The communication device of claim 8, wherein the digital signal processor accesses a look-up table to correct for a phase error imbalance between the I and Q branch signals.

10. The communication device of claim 8, wherein the digital signal processor iteratively adjusts the phase difference between the I and Q brach signals until there is no phase error.

11. A method of controlling a digital signal processor for correcting a phase error imbalance between in-phase and quadrature components of a calibration signal comprising the acts of:
adjusting a phase angle to set the amplitudes for the in-phase (I) and quadrature (Q) components of the calibration signal to be approximately equal at the same time;
sending a sine wave signal Sin(ω_{BB}.t) through the I and Q branches to measure I ₛᵢₙ(t) and Q ₛᵢₙ(t);
sending a cosine wave signal Cos(ω_{BB}.t) through the I and Q branches to measure Q _{cos}(t) and I _{cos}(t);
computing |I ₛᵢₙ(t) Q _{cos}(t)−I _{cos}(t) Q ₛᵢₙ(t)|=K3. Sin(Δφ_{BB}); and
adjusting center frequencies of all-pass networks within the in-phase and quadrature signal paths so that the in-phase and quadrature components of the calibration signal are 90 degrees out of phase.

12. The method of claim 11, wherein the I and Q branch calibration signals are produced by a double side band suppressed carrier signal.

13. The method of claim 11, wherein the digital signal processor varies the center frequencies of the all-pass networks.

14. The method of claim 13, wherein a relationship between center frequencies of the all-pass networks and Δφ_{BB} is linear.

15. The method of claim 13, wherein the digital signal processor controls a second phase shifter to adjust Δφ_{BB} as determined from a look-up table.

16. A radio transceiver comprising:
a quadrature receiver for receiving signals and converting the received signals into in-phase baseband and a quadrature baseband signals, wherein the quadrature receiver contains mixers, amplifiers and filters in both an in-phase signal path and a quadrature signal path,
all-pass networks in both the in-phase and quadrature signal paths, and
a digital signal processor for adjusting the center frequencies of the all-pass networks in order to minimize a phase error between the in-phase and quadrature signals.

17. The radio receiver in claim 16, wherein the center frequencies of the all-pass networks are maintained by the digital signal processor to be different from one another.

18. The radio receiver in claim 17, wherein the center frequencies of the all-pass networks are maintained by the digital signal processor so as to provide a linear relationship between phase angle and frequency.

19. The radio receiver in claim 18, wherein the all-pass networks provide a phase shift of the signals.

20. The radio receiver in claim 19, wherein the center frequencies of the all-pass networks are adjusted by the digital signal processor after a phase error has been previously determined.
